(19) United States
(12) Patent Application Publication
(10) Pub. No.: US 2010/0302205 A1
(43) Pub. Date: Dec. 2, 2010

(54) TOUCH PANEL SYSTEM

(75) Inventor: Mutsuaki NOMA, Fukuoka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/789,871

(22) Filed: May 28, 2010

(30) Foreign Application Priority Data
May 29, 2009 (JP) 2009-129884

(51) Int. Cl. G06F 3/045

(52) U.S. Cl. 345/174

(57) ABSTRACT

A touch panel system includes a closeness detection section 102 for detecting whether or not a position pointing member is brought close to a touch panel, a coordinate calculation section 108 for calculating the coordinate value on the detection face when the position pointing member is brought close to the detection face, and a control unit 100 for displaying the setting of the current set function at a position of the detection face corresponding to the coordinate value if the closeness detection section 102 detects that the position pointing member is close to the detection face for a preset first time or more.

### BACKGROUND

1. Field of the Invention

This invention relates to a touch panel system which enables the user to easily set and change the touch panel function and has a feature of display of the setup state.

2. Description of the Related Art

In recent years, a touch panel system of an electronic blackboard, etc., including a display for displaying an image, a coordinate input unit having a coordinate input face (touch face) disposed as a detection face on the front of the display, and a controller for performing display control of the display based on input from the coordinate input unit, wherein the display and the coordinate input unit are used to form a display face and a coordinate input face on the same face, has been provided.

As a coordinate detection art in the coordinate input unit used with the electronic blackboard, etc., as mentioned above, a touch panel of a system wherein the coordinate input face (touch face) is provided with a special function for detecting characteristic change caused by touch (contact) is often used; for example, an electrostatic capacity system, an ultrasonic surface acoustic wave system, etc., is known.

In the coordinate input unit adopting the electrostatic capacity system, etc., for example, to enable the user to precisely and easily switch the operation mode of setting a drawing color and the thickness of a drawing pen and to provide good ease of use, for example, Patent Document 1 discloses a tablet of a voice electronic notebook for detecting a stylus pen approaching a coordinate input face and enabling the user to select a playback method of voice information without operating a changeover switch of the operation mode.

Patent Document 1: Japanese Patent Laid-Open No. 2002-297308

The conventional operation mode switching is predicated on operation on a screen of a personal computer or in a device having an input function of single touch. Therefore, for example, to select another drawing color, first the user needs to select an icon placed as a menu or a command palette (simply palette) displayed on a screen by click, etc., and switch from the drawing mode to a color selection mode, etc. In such a configuration, after selecting a color, the user needs to again use the command palette, etc., to switch to the drawing mode for preventing erroneous determination of command input between the color selection mode, etc., and the drawing mode.

The art disclosed in Patent Document 1 is characterized in that the proximity state of a non-touch state on the touch face is assigned to a predetermined operation mode, but does not change from the concept of the conventional operation mode switching in principle.

However, if frequent switching occurs between the drawing mode and the color selection mode, it takes time in repeating the operation sequence.

Particularly, for a large coordinate input unit such as a whiteboard, for example, the following situation occurs and the usability of the coordinate input unit is very poor for the user: A short infant does not reach a palette set in an upper part and may be unable to operate the palette. If the palette is installed in the left or right end part, even an adult must move largely left or right and operability is poor. Even if the palette position is made changeable, if more than one person operates, there is a problem in that operability is not ensured depending on the positional relationship between the operators.

### SUMMARY

It is an object of the invention to provide a touch panel system enabling the user to easily recognize setup information on a coordinate input face (touch face) as a detection face and further enabling the user to change setting by easy operation.

Accordingly, it is made possible for the user to check the setting of the current set function by bringing the pointing member of a finger, a stylus pen, etc., for example, close to the touch panel (detection face).

Accordingly, the user brings the position pointing member of a finger, a stylus pen, etc., for example, close to the touch panel (detection face) and once brings the position pointing member away from the touch panel and then again brings the position pointing member close to the touch panel, whereby it is made possible to switch and display the setting of a selectable function and select it.

Accordingly, the user can bring the pointing member close to or away from the surface of the touch panel, thereby knowing the setting of the current drawing color by the first closeness action and can switch the setting of the drawing color by the second or later closeness action and if the user brings the pointing member into contact with the touch panel following any of the closeness actions, the later drawing color can be determined.

Accordingly, it is made possible for the user to check the setting of the current set function by bringing the pointing member of a finger, a stylus pen, etc., for example, close to the touch panel (detection face).

Accordingly, the user brings the position pointing member of a finger, a stylus pen, etc., for example, close to the touch panel (detection face) and once brings the position pointing member away from the touch panel and then again brings the position pointing member close to the touch panel, whereby it is made possible to switch and display the setting of a selectable function and select it.

According to the invention, the operator can operate the system without largely moving the operation position and his or her eyes from the vicinity of the area to draw without the need for a palette or menu to switch the operation mode, so that the user can select another drawing color and subsequently draw rapidly. Moreover, the operator performs natural operation for switching between the color selection mode and the drawing mode, so that erroneous determination between the color selection mode and the drawing mode can be circumvented.

### BRIEF DESCRIPTION OF THE DRAWINGS

In the accompanying drawings:

FIG. 1 is a schematic representation to show a touch panel system according to Embodiment 1 of the invention;

FIG. 2 is a block diagram to show the configuration of a coordinate detection unit and a control section of an interactive board forming a part of the touch panel system according to Embodiment 1 of the invention;

FIG. 3 is a functional block diagram to show the control function of the touch panel system according to Embodiment 1 of the invention;

FIG. 4 is a schematic representation to show a state in which a check marker is displayed in the touch panel system according to Embodiment 1 of the invention;

FIG. 5 is a flowchart of closeness determination of a position pointing member in the touch panel system according to Embodiment 1 of the invention;

FIG. 6 is a flowchart to show color change processing in the touch panel system according to Embodiment 1 of the invention;

FIG. 7 is a flowchart of contact determination of the position pointing member in the touch panel system according to Embodiment 1 of the invention;

FIG. 8 is a configuration drawing of the coordinate detection unit in the touch panel system according to Embodiment 1 of the invention;

FIG. 9 is a timing chart to show the operation of the coordinate detection unit in the touch panel system according to Embodiment 1 of the invention.

FIG. 10 is a configuration drawing of a detection circuit of the coordinate detection unit in the touch panel system according to Embodiment 1 of the invention;

FIG. 11 is a sectional view to show a state in which a position pointing member is brought into contact with a touch panel in the touch panel system according to Embodiment 1 of the invention;

FIG. 12 is a schematic representation to show a detection signal provided by the detection circuit forming a part of the touch panel system according to Embodiment 1 of the invention;

FIG. 13 is a schematic representation to show a detection signal provided by the detection circuit forming a part of the touch panel system according to Embodiment 1 of the invention; and

FIG. 14 is a sectional view of the detection circuit forming a part of the touch panel system according to Embodiment 1 of the invention.

### DESCRIPTION OF THE PREFERRED EMBODIMENTS

A touch panel system according to Embodiment 1 of the invention will be discussed below with reference to the accompanying drawings:

### Embodiment 1

In the description to follow, it is to be understood that the invention is one embodiment and is not limited to the configuration or the mode described below.

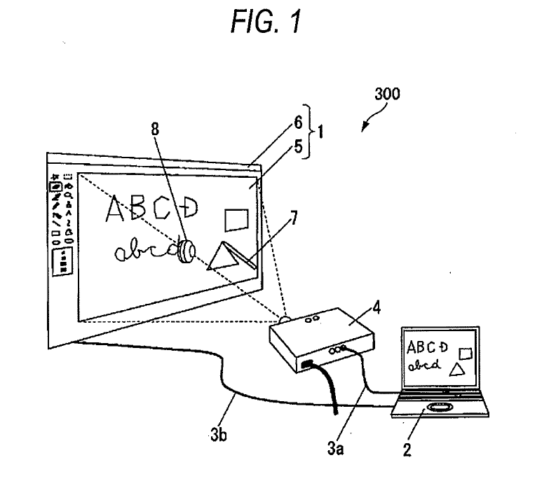

FIG. 1 is a schematic representation to show the touch panel system according to Embodiment 1 of the invention.

An interactive board 1 forming a part of a touch panel system 300 detects the locus of handwrite using a position pointing member 7 of a finger, a stylus pen, etc. In Embodiment 1, the interactive board 1 has a position detection function according to an electrostatic capacity system described later in detail.

In the touch panel system 300, display data of a character, a picture, a pattern, graphics, etc., stored in a computer 2 is sent to a projector 4 connected through a communication cable 3a and the same image of the character, the picture, the pattern, the graphics, etc., as that on a screen of the computer 2 can be projected onto the interactive board 1.

A display face and a write face of the interactive board 1 are implemented as a touch panel 5 as a detection face and a coordinate detection unit 6 provided in intimate contact with the touch panel 5 behind the touch panel 5, and enables the user to execute handwrite input using the position pointing member 7 of a finger, a stylus pen, etc. If the user handwrites a character, etc., with the position pointing member 7 on the touch panel 5, a signal indicating the locus of the handwrite is input by the coordinate detection unit 6 having matrix-like electrodes (detection electrodes described later in detail) and is converted into data by a circuit described later in the main body of the interactive board 1 and then the data is read into the computer 2 through a communication cable 3b. The handwrite locus data read into the computer 2 is combined with the display data of the character, the picture, the pattern, the graphics, etc. The composite display data is again projected onto the display face of the interactive board 1 as an image through the liquid crystal projector 4. The handwrite data input using the electronic pen 7 may be made able to be erased by an eraser 8.

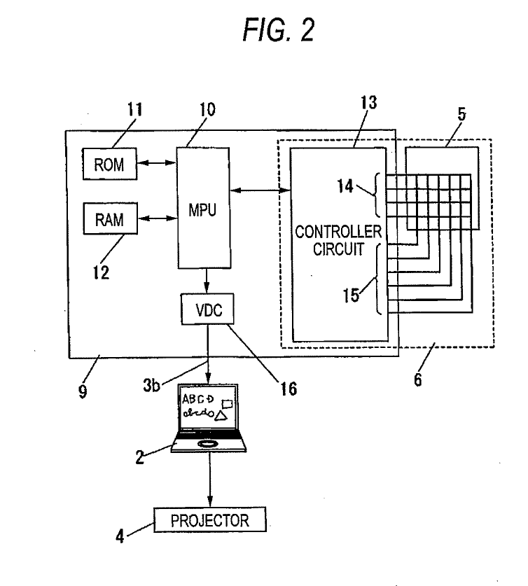

FIG. 2 is a block diagram to show the configuration of the coordinate detection unit and a control section of the interactive board forming a part of the touch panel system according to Embodiment 1 of the invention.

The control section 9 is made up of an MPU (Multi Processing Unit) 10 for controlling the whole interactive board 1, an interface with the computer 2, etc., ROM 11 storing a main program, device change status, etc., RAM 12 of memory for operating the main program, and a controller circuit 13 for controlling the coordinate detection unit 6.

The coordinate detection unit 6 includes the touch panel 5 forming a detection face and the controller circuit 13, and the touch panel 5 includes matrix electrodes made up of a plurality of row detection electrodes 14 and a plurality of column detection electrodes 15. In fact, the matrix electrodes are made up of a larger number electrodes than those shown in the figure. A signal output from the coordinate detection unit 6 through the controller circuit 13 is read into the MPU 10, which then performs processing of A/D conversion, etc., and then transmits the signal to the compute 2 through the cable 3b.

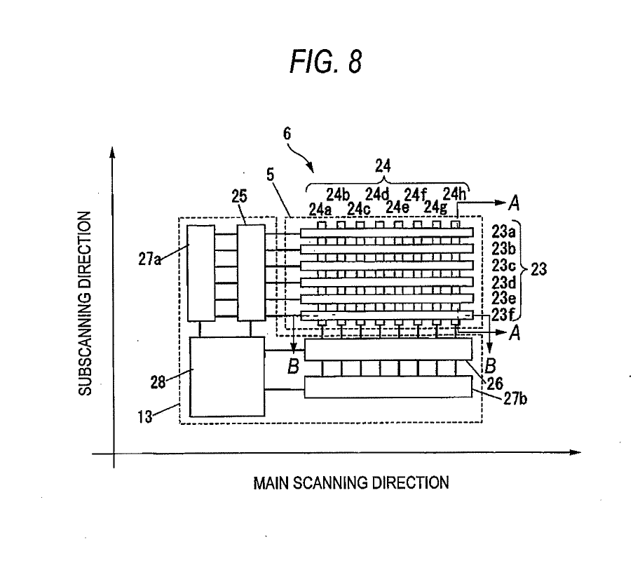

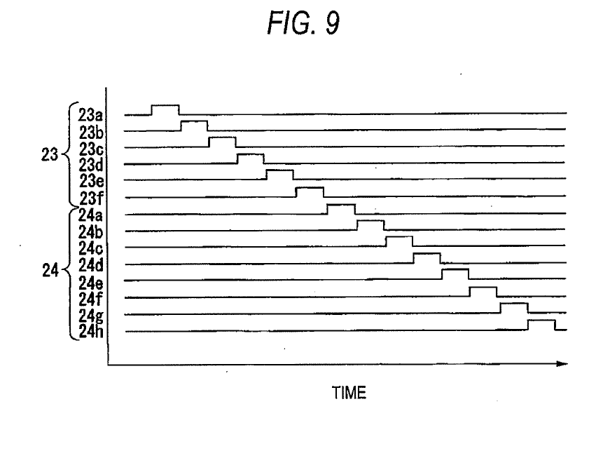

FIG. 8 is a configuration drawing of the coordinate detection unit in the touch panel system according to Embodiment 1 of the invention. FIG. 9 is a timing chart to show the operation of the coordinate detection unit in the touch panel system according to Embodiment 1 of the invention.

The configuration of the coordinate detection unit 6 will be discussed below in detail:

In FIG. 8, for example, the coordinate detection unit 6 is placed on the display face of the display or is incorporated in the electronic blackboard, etc., (however, the actual surface of the coordinate detection unit 6 is coated with a protective layer, etc., covering the surface of the touch panel 5 and the configuration in FIG. 8 cannot directly be visibly recognized).

Numeral 5 denotes the touch panel (detection face) described above and the touch panel 5 occupies most of the whole of the coordinate detection unit 6. The user can bring the above-described position pointing member 7 (not shown) into contact with the surface of the touch panel 5, thereby indicating the content projected onto or displayed on the surface of the touch panel 5 or directly pointing to the coordinate position in the electronic blackboard, a tablet, etc., and inputting into an information processing apparatus of the computer 2, etc.

Numerals 23, 23a, and 23b to 23f denote a plurality of detection electrodes extended in parallel with each other along a main scanning direction of the touch panel 5 (they correspond to the row detection electrodes 14 described above and hereinafter may be collectively called “first electrodes 23”). Numerals 24, 24a, and 24b to 24h denote a plurality of detection electrodes extended in parallel with each other along a subscanning direction of the touch panel 5 (the direction orthogonal to the main scanning direction) (they correspond to the column detection electrodes 15 described above and hereinafter may be collectively called “second electrodes 24”).

In FIG. 8, for convenience, six first electrodes 23 and eight second electrodes 24 are placed; for example, to use the coordinate detection unit 6 as input means of a large device, such as an electronic blackboard, the numbers are increased. Specifically, if the electronic blackboard is 200 cm wide and 150 cm long (4:3 layout) and the detection electrode placement pitch is set to 1 cm, 200 first electrodes 23 and 150 second electrodes 24 are placed.

Numeral 25 denotes a row detection electrode selection circuit for controlling whether or not to enable the position detection operation about the first electrodes 23. Numeral 26 denotes a column detection electrode selection circuit for controlling whether or not to enable the position detection operation about the second electrodes 24.

Numeral 27a and 27b denote detection circuits for operating in response to output of the row detection electrode selection circuit 25 and the column detection electrode selection circuit 26. The detection circuits 27a and 27b include predetermined oscillation circuits, etc., and detect change in the electrostatic capacity of the first electrode 23 and the second electrode 24. Numeral 13 denotes the controller circuit described above. The controller circuit 13 includes the row detection electrode selection circuit 25, the column detection electrode selection circuit 26, the detection circuits 27a and 27b, and a timing generation circuit 28 for controlling the circuits.

The process of coordinate position detection in the coordinate detection unit 6 in Embodiment 1 will be discussed below in detail with FIGS. 8 and 9:

First, the first electrodes 23a and 23b to 23f are selected in order (a pulse signal is applied in a predetermined time period) by the row detection electrode selection circuit 25 controlled by the controller circuit 13, whereby the first electrodes 23a and 23b to 23f are scanned.

Subsequently, the second electrodes 24a and 24b to 24h are selected in order (a pulse signal is applied in a predetermined time period) by the column detection electrode selection circuit 26 controlled by the controller circuit 13, whereby the second electrodes 24a and 24b to 24h are scanned.

When a pulse is applied to each of the detection electrodes (the first electrodes 23 and the second electrodes 24), the electrostatic capacity change amount of each of the detection electrodes is detected by the detection circuits 27a and 27b and the first electrode 23 and the second electrode 24 corresponding to the position touched by the position pointing member 7 (not shown) on the touch panel (detection face) 5 are uniquely determined based on the electrostatic capacity change amount and the position coordinates are found as a pair of the detection electrodes.

Since the detected electrostatic capacity change is an analog amount, the value provided by converting the analog amount into a digital amount has a predetermined range (Value). Since electrostatic capacity change is also observed in a detection electrode adjacent to a specific detection electrode, the position coordinates of the position touched by the position pointing member 7 can be detected with finer resolution than the detection electrode placement pitch based on information distributed on the two-dimensional face. The final coordinate value is determined by the MPU 10 described later (see FIG. 2) based on output of the coordinate detection unit 6.

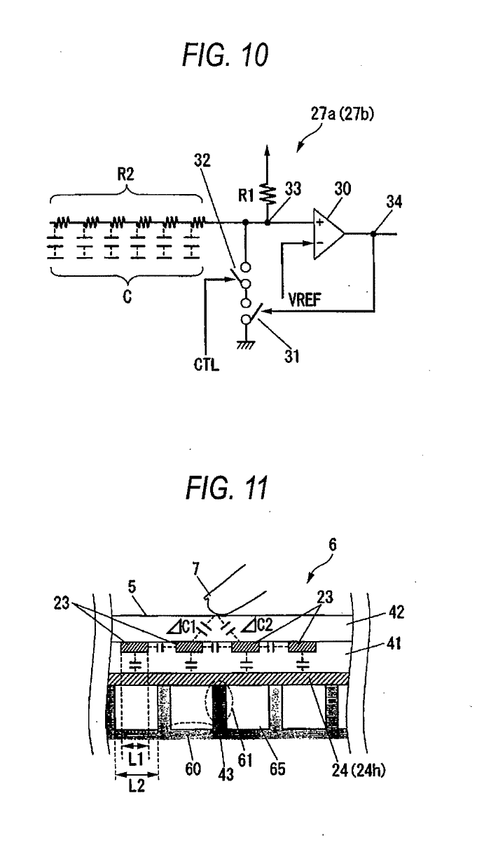

FIG. 10 is a configuration drawing of the detection circuit of the coordinate detection unit in the touch panel system according to Embodiment 1 of the invention; it is a configuration drawing of the detection circuit 27a, 27b of the coordinate detection unit 6.

The operation of the detection circuit 27a, 27b will be discussed below in detail with FIG. 10:

As shown in FIG. 10, the detection circuit 27a, 27b is made up of a time constant circuit including electrostatic capacity C containing the capacitance between the adjacent detection electrodes parallel with each other (line capacity), the capacitance produced as the row detection electrode (first electrode 23) and the column detection electrode (second electrode 24) cross each other, and stray capacitance and a resistor R1 and combined resistance R2 of the detection electrodes for determining a time constant, an operation control switch 32, a voltage comparator 30, and a charge and discharge switch 31.

The operation control switch 32 operates in accordance with output of the row detection electrode selection circuit 25 (the column detection electrode selection circuit 26) shown in FIG. 8; a CTL signal is turned ON during Hi period in the timing chart of FIG. 9 and the detection circuit 27a (27b) is controlled active.

The charge and discharge switch 31 is controlled by the voltage comparator 30. When the voltage of a node B34 connected to output of the comparator 30 is Hi, the charge and discharge switch 31 is controlled to ON; when the voltage of the node B34 is Low, the charge and discharge switch 31 is controlled to OFF.

The operation of the described detection circuit 27a, 27b will be discussed in detail.

When any of the first electrodes 23 (second electrode 24) is selected by the row detection electrode selection circuit 25 (namely, the selection signal in FIG. 9 goes Hi), the operation control switch 32 is set to ON and the operation of the detection circuit 27a (27b) is started. Then, the electrostatic capacity C is charged through the resistor R1 and a node A33 of an input node of the voltage comparator 30 rises. When the voltage of the node A33 reaches VREF accordingly, the voltage of the node B34 connected to output of the comparator 30 goes High and the charge and discharge switch 31 is set to ON. Accordingly, the capacitor is discharged in a stroke and the voltage of the node A33 becomes less than VREF. Since the output of the comparator 30 is restored Low because of the discharge, the switch is set to OFF and again charging of the electrostatic capacity C is started. Thus, the detection circuit 27a, 27b repeats charging and discharging the electrostatic capacity C to continue the oscillation state.

FIG. 11 is a sectional view to show a state in which the position pointing member is brought into contact with the touch panel in the touch panel system according to Embodiment 1 of the invention; it shows a state in which the position pointing member 7 is brought into contact with the surface of the touch panel 5 forming a part of the coordinate detection unit 6.

FIG. 11 shows a state in which the position pointing member 7 (in FIG. 11, a finger) comes into contact with the surface of the touch panel 5 in the cross section taken on line A-A in FIG. 8.

In FIG. 11, numeral 41 denotes a support body for supporting the first electrode 23 as a detection electrode on a first face of the support body and the second electrode 24 as a detection electrode on the back of the first face (second face) with the first electrode 23 and the second electrode 24 spaced from each other. The support body 41 is a flat sheet formed of a resin of PET, etc., having a thickness of 70 μm to 250 μm, for example, and the above-described detection electrodes are patterned on the surface and the back of the support body 41. In this point, the support body 41 has a function as a flexible electrode substrate.

The first electrodes 23 and the second electrodes 24 placed on the surface and the back of the support body 41 can be formed by a print method, an ink jet method, a nozzle printing method using ink containing silver particles, for example.

Numeral 42 denotes a protective layer (surface member) provided on the surface of the touch panel 5 for insulating the detection electrodes (first electrodes 23) from the outside and protecting the detection electrodes against finger or any other physical contact. The protective layer (surface member) 42 is formed of phenol resin, etc., having a thickness of 0.25 mm to 2 mm, for example.

In Embodiment 1, the expression “protective layer” is used for convenience, but the invention can be applied regardless of whether or not the effect of protecting the support body 41 from the outside exists.

Numeral 43 denotes a reinforcing material (rear member) for preventing deformation of the touch panel 5 by physical touch of the position pointing member 7 or any other member and preventing a break of the detection electrode. The reinforcing material 43 supports the support body 41 from an opposite face (rear face) to the protective layer 42; the whole thickness of the reinforcing material 43 is not limited and an appropriate thickness can be selected according to the use mode and the installation environment of the coordinate detection unit 6.

In Embodiment 1, the expression “reinforcing material” is used for convenience, but the invention can be applied regardless of whether or not the effect of reinforcing so that the support body 41 does not become deformed, etc., exists.

The protective layer 42, the support body 41, and the reinforcing material 43 are adhered with an adhesive and are deposited in this order.

Numeral 7 denotes the position pointing member described above. To use any other than a finger as the position pointing member 7, preferably the part of the position pointing member 7 for coming in contact with the surface of the touch panel 5 uses, for example, highly flexible felt, particularly, conductive felt so that a predetermined contact area can be ensured.

After this, the structure of the reinforcing material 43 will be discussed in detail:

In Embodiment 1, the reinforcing material 43 is formed of a resin of polypropylene, polystyrene, etc., having a low dielectric constant, for example, and is a member including convexes and concaves; the height from a concave part 60 to a convex part 61 is set to 0.5 mm, for example, and while degradation of the whole strength in the presence of the concave parts 60 is prevented, each of the concave parts 60 forms a gas layer (space part) 65 between the reinforcing material 43 and the support body 41.

Each of the concave parts 60 (the gas layer 65 formed by the concave part) is placed so as to be superposed on the cross position of the first electrode 23 and the second electrode 24 of the detection electrodes. The concave part has a size such that L1<L2 holds where L1 is the width of the detection electrode and L2 is the range of the concave part 60.

In Embodiment 1, such a concave and convex structure is adopted, whereby an electric coupling path is shut off and it is made possible to detect capacitance component change with high accuracy when the position pointing member 7 is brought into contact with the surface of the touch panel 5.

The reinforcing material 43 having concaves and convexes can be formed by mold press, for example. In FIG. 11, the convex part 61 is drawn upright from the concave part 60, but preferably the shape is a trapezoid, etc., for example, considering the mold release characteristics.

FIG. 11 is a sectional view taken on line A-A in FIG. 8 as described above; the cross section taken on line B-B in FIG. 8 also includes a similar structure.

In FIG. 11, one of the first electrode 23 and the second electrode 24 is provided on one face of the support body 41 and the other is provided on the opposite face of the support body 41 and the first electrodes 23 and the second electrodes 24 sandwich the support body 41, but the first electrode 23 and the second electrode 24 may be provided on a single face of the support body 41 and an insulating layer (not shown) may be provided between the detection electrodes.

If the detection electrodes are thus provided on a single face of the support body 41, when the detection electrodes are worked, the number of work faces becomes one and the process is simplified.

The insulating layer may adopt a configuration of putting a sheet formed of PET, etc., for example, (at this time, the detection electrodes 23 or 24 are previously formed on the sheet face) or an insulating material of a resin, etc., may be applied to the support body 41 formed with the first electrodes 23 to form an insulating layer and the second electrodes 24 may be formed directly on the surface of the insulating layer by a transfer method, a print method, an ink jet method, a nozzle printing method, etc.

The forming order of the first electrodes 23 and the second electrodes 24 may be exchanged. The insulating layer forming range may be a linear portion covering only the forming area of the detection electrodes 23 or 24 or only a portion crossing the later formed detection electrodes (in this case, the insulation layer is not formed on all face of the touch panel 5 and forms an insulating part in the sense of a linear or dotted shape. In so doing, it is made possible to reduce the material cost.

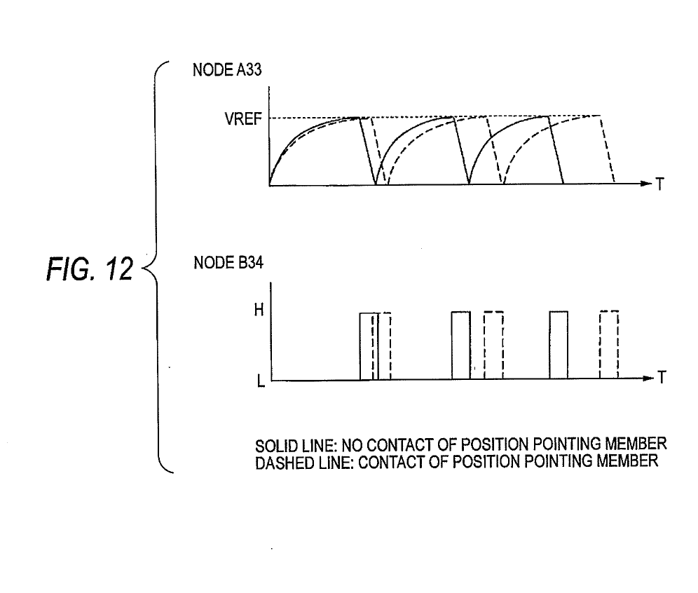

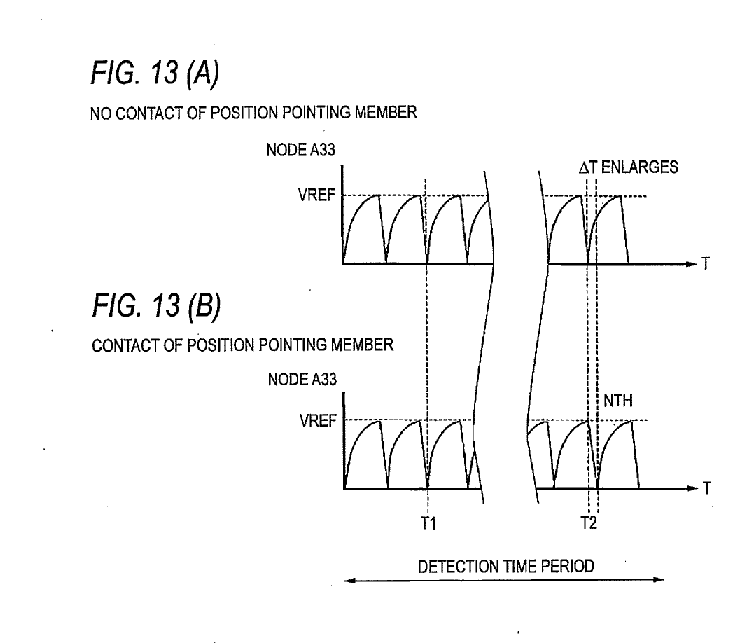

FIGS. 12 and 13 are schematic representations to show detection signals provided by the detection circuit forming a part of the touch panel system according to Embodiment 1 of the invention; they are schematic representations to show detection signals provided by the detection circuit 27a, 27b in Embodiment 1 of the invention.

Change in the electrostatic capacity when the position pointing member 7 is brought into contact with the protective layer 42 of the touch panel 5 will be discussed below with FIGS. 11 to 13:

When the position pointing member 7 comes in contact with the protective layer 42 of the touch panel 5, in addition to the electrostatic capacity C described above, ΔC1, ΔC2 is added to the detection electrode placed in the proximity of the touch part, as shown in FIG. 11. As indicated by the dashed line in FIG. 12, when the position pointing member 7 comes in contact, the electrostatic capacity increases as compared with the case where the position pointing member 7 does not come in contact, and the time until VREF is reached increases and thus the period is prolonged and accordingly, the first 23 and the second electrode 24 involved in the touch (contact) can be determined.

In actual detection, the period difference caused by the presence and absence of contact (touch) of the position pointing member 7 is extremely small and detection of the difference much contains an error in the former half part (T1) in a predetermined detection time period as shown in FIG. 13 (the time period during which the selection signal is Hi previously described with FIG. 9). Therefore, preferably the time difference of the Nth period (ΔT) is detected in the latter half (T2) of the detection time period where the period differences are accumulated. Hereinafter, detection of change in the electrostatic capacity according to the time difference of the Nth period will be called “detection based on change in the electrostatic capacity” and the obtained detection value will be called “detection level” or simply “detection value.”

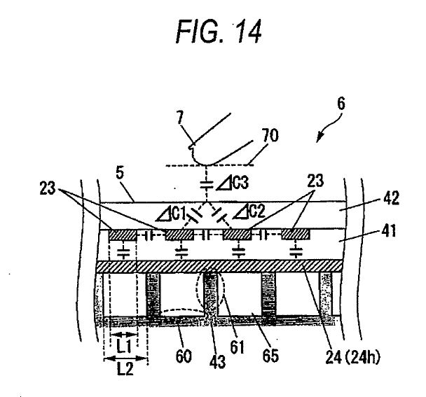

FIG. 14 is a sectional view of the detection circuit forming a part of the touch panel system according to Embodiment 1 of the invention; it is a sectional view to show a state in which the position pointing member 7 is brought close to the surface of the touch panel 5 forming a part of the coordinate detection unit 6.

FIG. 14 shows a state in which the position pointing member 7 (in FIG. 11, a finger) is close to the surface of the touch panel 5 in the cross section taken on line A-A in FIG. 8.

When the position pointing member 7 is brought close to the protective layer 42 of the touch panel 5, in addition to the electrostatic capacity C described above, ΔC1, ΔC2, ΔC3 is added to the detection electrode placed near the proximity part, as shown in FIG. 14. Theoretically, ΔC3 is added, whereby the fact that the position pointing member 7 is brought close to the surface of the touch panel 5 can be detected; however, since ΔC3 is added through space, change in the electrostatic capacity is extremely minute as compared with the whole electrostatic capacity C.

Then, in Embodiment 1, the MPU 10 (see FIG. 2) acquires detection values about all detection electrodes and further prolongs the measurement time period T2 previously described with FIG. 13 (the measurement time period set by the MPU 10 is Tx) in a state in which the maximum value does not reach a predetermined value, and gives the measurement time period of Tx=T2×4 at the maximum, for example, detects based on change in the electrostatic capacity. Accordingly, it is also made possible to precisely detect minute electrostatic capacity change.

As the position pointing member 7 is gradually brought close to the touch panel 5, the detection level rises accordingly. At this time, the MPU 10 sets the enlarged measurement time period Tx gradually short. That is, the measurement time period Tx is set to T2×4 at the maximum and adjusts the measurement time period Tx so that the maximum value of the detection values acquired about all detection electrodes is set roughly constant.

Thus, in Embodiment 1, the MPU 10 sets the measurement time period Tx and references the detection value obtained by detection based on change in the electrostatic capacity and the measurement time period Tx when the detection value is acquired, thereby determining whether the actually acquired detection value is the value caused by “contact (touch)” or “closeness (proximity).”

That is, for example, if a predetermined detection value is acquired in the state in which the measurement time Tx is 2T, the MPU 10 determines that the position pointing member 7 is in “contact” with the touch panel 5; if a predetermined detection value is acquired in the state in which the measurement time Tx is 2T×4, the MPU 10 determines that the position pointing member 7 exists in an “outer area of distance recognized as closeness (proximity) (which will be hereinafter called “outer area 70;” if a predetermined detection value is acquired in the state in which the measurement time Tx is 2T<Tx<2T×4, the MPU 10 determines that the position pointing member 7 exists inside the outer area 70 and in the range of noncontact (which will be hereinafter called “closeness range 71”).

Further, if the position pointing member 7 exists in the closeness range 71, the MPU 10 can also determine the distance as to how much the position pointing member 7 is distant from the surface of the touch panel 5 based on the measurement time Tx.

When the position pointing member 7 is brought close to the touch panel 5 (more precisely, the position pointing member 7 is brought close to the touch panel 5 inside the outer area 70), display occupying a comparatively large area is produced on the touch panel 5 and thus the accuracy for detecting the position coordinates may be made lower than that when the position pointing member 7 is in contact with the touch panel 5 and even if the measurement time period Tx is prolonged and one sampling period executed for all detection electrodes becomes large, the operation of the whole system is scarcely affected.

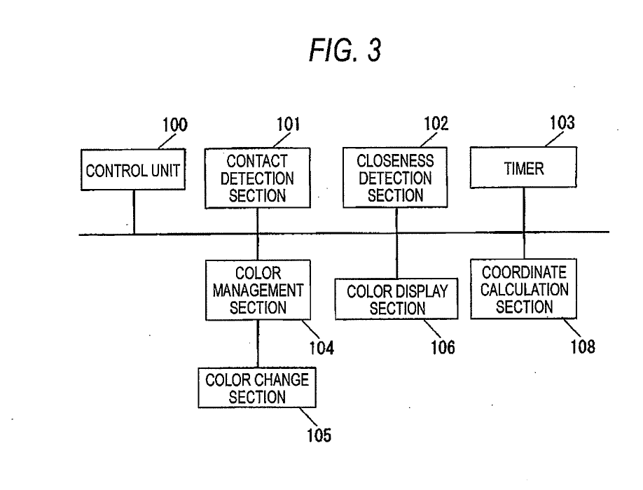

FIG. 3 is a functional block diagram to show the control function of the touch panel system according to Embodiment 1 of the invention.

In Embodiment 1, the functional components in FIG. 3 are executed all by the MPU 10, but may be implemented on a predetermined board, for example, as physically independent components.

In the description to follow, for convenience, it is assumed that the functional components exist as independent components.

In FIG. 3, numeral 101 denotes a contact detection section. The contact detection section 101 determines whether or not the position pointing member 7 comes in contact with the touch panel 5 on the interactive board 1 based on the process described above.

Numeral 102 denotes a closeness detection section. The closeness detection section 102 detects whether or not the position pointing member 7 is brought close to the touch panel 5 on the interactive board 1 in one certain closeness range (the closeness range 71 in the range close to the touch panel 5 from the outer area described above) based on the process described above. If the position pointing member 7 is placed out of the closeness range 71 on the touch panel 5, output of a detection signal is stopped or a non-detection signal is output.

Numeral 108 denotes a coordinate calculation section. If the contact detection section 101 or the closeness detection section 102 detects that the position pointing member 7 comes in contact with the touch panel 5 or is brought close to the closeness range 71, the coordinate calculation section 108 calculates the position coordinates of the position on the touch panel 5 with which the position pointing member 7 comes in contact or the point where the normal pulled down from the position pointing member 7 to the touch panel 5 and the touch panel 5 cross each other and its surrounding proximity. More particularly, the coordinate calculation section 108 extracts the detection electrode significantly detecting the contact or closeness state based on the detection values for all detection electrodes output from the coordinate detection unit 6 (see FIG. 2, etc.,) and uses the position information corresponding to the extracted detection electrode to calculate plane coordinate value x, y on the touch panel (detection face) 5 to which the position pointing member 7 is brought close (which will be hereinafter called simply “coordinate value”).

Numeral 103 denotes a timer as a time count section having a time count function. If the closeness detection section 102 detects that the position pointing member 7 is brought close to the touch panel 5, the timer 103 counts the time during which the position pointing member 7 stays (exists) within a predetermined range from the touch panel 5. This is defined as first closeness determination time and second closeness determination time (described layer).

Numeral 104 denotes a color management section. The color management section 104 manages the preset color type, the color display order, and the color selected as the current display color (namely, drawing color drawn when the position pointing member 7 comes in contact with the touch panel 5 and writes).

Numeral 105 denotes a color change section. If the closeness detection section 102 detects that the position pointing member 7 is brought close to the touch panel 5 on the interactive board 1 again within the second closeness determination time, the color change section 105 manages change processing from the current color to another color.

Numeral 106 denotes a color display section. If the closeness detection section 102 detects that the position pointing member 7 is brought close to the touch panel 5 on the interactive board 1 continuously for the first closeness determination time or more, the color display section 106 displays the color selected as the current drawing color in the area containing the coordinate value of the touch panel 5 calculated by the coordinate calculation section 108 described above as a check marker 201 or a color setting menu (strictly, generates data to control the display as described below).

Numeral 100 denotes a control unit; for example, a CPU (Central Processing Unit), etc., can be used as the control unit 100. The control unit 100 controls the contact detection section 101, the closeness detection section 102, the timer 103, the color management section 104, the color change section 105, the color display section 106, and the coordinate calculation section 108 in association with each other as a whole.

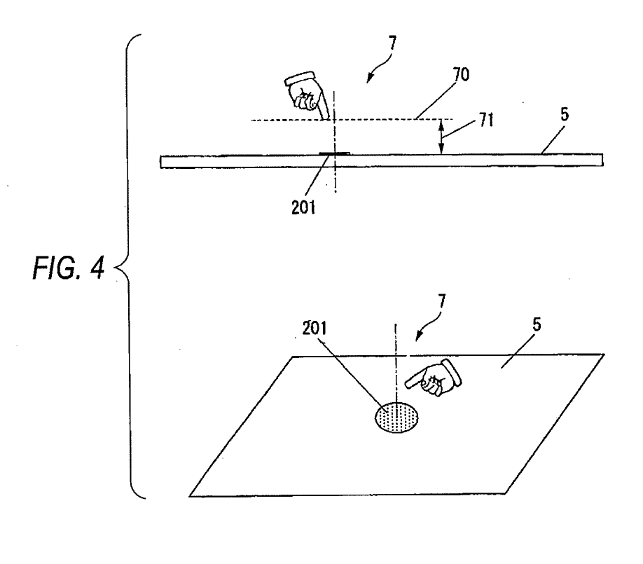

FIG. 4 is a schematic representation to show a state in which a check marker is displayed in the touch panel system according to Embodiment 1 of the invention; it shows a state in which the check marker 201 is displayed on the touch panel 5 in a state in which the position pointing member 7 is brought close to the touch panel 5.

If the position pointing member 7 exists in the closeness range 71, the detection value based on change in the electrostatic capacity described above indicates “the outer area 70” or “the closeness range 71.” The closeness detection section 102 finally determines that the position pointing member 7 is close to the touch panel 5 on the interactive board 1 rather than is in contact with the touch panel 5 provided that determination of “the outer area 70” or “the closeness range 71” continues when the first closeness determination time or the second closeness determination time measured by the timer 103 has elapsed.

At this time, in Embodiment 1, the check marker 201 of the same color as the color set as the drawing color, of the current setup state of the touch panel system 300, as shown in FIG. 4. The display position of the check marker 201 is the position corresponding to the coordinates on the touch panel 5 calculated by the coordinate calculation section 108 (see FIG. 3) or its proximity position. Alternatively, the check marker 201 may be displayed at a predetermined position different from the position corresponding to the coordinates on the touch panel 5 calculated by the coordinate calculation section 108 (see FIG. 3) or its proximity position.

In Embodiment 1, information displayed at the corresponding position contains not only the check marker 201, etc., but also a selection menu of the color type, the line type, the font, etc., of the marker, menu display for selecting an icon or any other tool, a mode, etc., for displaying a selection function, etc., which are collectively defined as “information menu.”

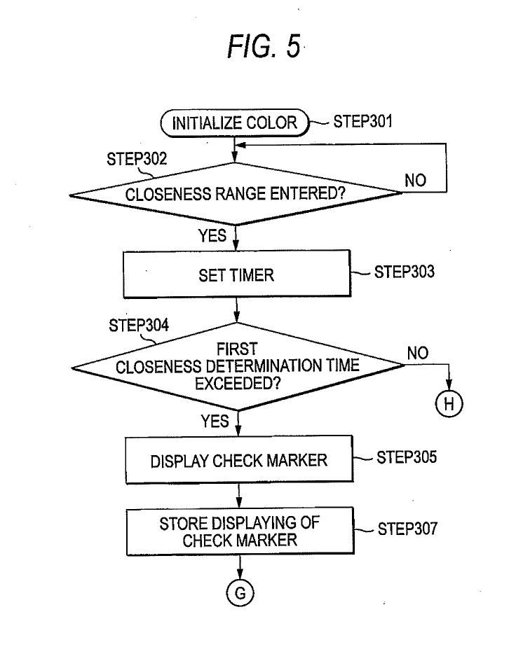

FIG. 5 is a flowchart of closeness determination of the position pointing member in the touch panel system according to Embodiment 1 of the invention; it shows a procedure of determining whether or not the position pointing member 7 is brought close to the touch panel (detection face) 5.

The determination processing will be discussed below in detail with FIG. 5 together with FIGS. 3 and 4:

As described above, in Embodiment 1, the MUP 10 (see FIG. 2) executes the processing based on the program stored in the ROM 11. However, in the description to follow, for convenience, it is assumed that the independent components shown in FIG. 3 execute the processing.

First, the control unit 100 initializes the color of the check marker 201 to a predetermined color and the color management section 104 stores the color information (STEP301). At this time, the same color as the drawing color is set as the display color of the check marker 201.

The closeness detection section 102 determines whether or not the position pointing member 7 exists in the closeness range, and waits for the position pointing member 7 to enter the closeness range (STEP302).

If the closeness detection section 102 determines that the position pointing member 7 enters the closeness range 71, the closeness detection section 102 sends the determination result to the control unit 100, which then sets the first closeness determination time in the timer 103 and count of the timer 103 is started (STEP303). The first closeness determination time may be set to about 0.5 to 0.8 sec, for example.

The closeness detection section 102 always continues to detect that the position pointing member 7 is in the closeness range 71. The control unit 100 references the detection result of the closeness detection section 102 in a predetermined period even while the first closeness determination time is counted.

Next, the control unit 100 determines whether or not the count of the timer 1 exceeds the first closeness determination time while the detection result of the closeness detection section 102 remains the closeness range 71 (STEP304). Specifically, if the timer 103 outputs an interrupt signal (IRQ) to the control unit 100 at the termination of the count. The control unit 100 recognizes count completion according to the signal IRQ.

If the control unit 100 determines that the first closeness determination time is exceeded, the control unit 100 instructs the color display section 106 to display the color information selected as the current drawing color as the check marker 201 or color setting menu based on the color information stored in the color management section 104.

Specifically, the control unit 100 acquires color information from the color management section 104 and transmits the color information to the MPU 10. The MPU 10 transmits attribute information, etc., of the object to be displayed containing the coordinates and color information to be displayed through a VDC (Video Display Controller) 16 (see FIG. 2) to the computer 2 (see FIG. 2) through the communication cable 3b. The computer 2 generates image data based on the acquired color information and sends the image data through the communication cable 3a to the projector 4 (see FIGS. 1 and 2). Accordingly, the check marker 201 is displayed on the touch panel 5.

Next, the control unit 100 stores the current state as the display state of the check marker 201 (STEP307).

As shown in FIG. 4, the check marker 201 or the color setting menu is displayed in the area containing the coordinates determined to be “closeness.” At this time, the check marker 201 may be displayed as any shape if the user can recognize that it is a marker; not only a circle shown in FIG. 4, but also any shape that can be precisely visually recognized may be adopted.

Preferably, the thickness of the color displayed as the check marker 201 or the color setting menu is made lighter color than the actual drawing color rather than intact color if the color selected as the drawing color can be determined. The check marker 201 is displayed on the touch panel 5 as described above; in fact, however, it is not actually drawn (written) on the touch panel 5. Therefore, the color of the check marker 201 is displayed light, whereby it is made possible for the user to easily recognize that the current display is the check marker 201.

As described above, in the closeness range 71, the control unit 100 can also measure the distance between the touch panel (detection face) 5 and the position pointing member 7 based on the detection result of the closeness detection section 102 (namely, the closeness detection section 102 also serves as a distance detection section). Thus, preferably change is added to the display mode of the check marker 201 in response to the distance.

For example, the color of the check marker 201 can be changed from light color (namely, low chroma saturation state or high brightness state) to the actually written drawing color so that the color becomes closer to the actual drawing color as the distance becomes shorter.

In so doing, it is made possible for the user to recognize the distance between the position pointing member 7 and the touch panel 5 by intuition; ease of use is further enhanced.

Further, the size of the check marker 201 may be changed in response to the distance. For example, the larger the distance, the larger the size of the check marker 201; the smaller the distance, the smaller the size of the check marker 201. In so doing, it is made possible for the user to recognize the distance by intuition; ease of use is further enhanced.

Thus, the touch panel system according to Embodiment 1 includes the touch panel (detection face) 5, the closeness detection section 102 for detecting whether or not the position pointing member 7 is brought close to the touch panel 5, and the closeness coordinate calculation section (the coordinate calculation section 108) for calculating the coordinate value in the touch panel 5 when the position pointing member 7 is brought close to the touch panel 5 based on the detection result of the closeness detection section 102. The touch panel system further includes the control section (the control unit 100, the color display section 106, etc.,) for displaying the current “function setting” in the part of the touch panel 5 corresponding to the coordinate value if the closeness detection section 102 detects that the position pointing member 7 is close to the touch panel 5 for the preset first time or more (first closeness determination time).

Accordingly, it is made possible for the user to check the setting of the current setup function by bringing the position pointing member 7 of a finger, a stylus pen, etc., close to the touch panel (detection face) 5.

The “function setting” is setting of color used for drawing and the control section (the control unit 100, the color display section 106, etc.,) displays the color used for drawing as the check marker on the touch panel 5 as the detection face.

Accordingly, the user brings the position pointing member 7 of a finger, a stylus pen, etc., close to the touch panel (detection face) 5, for example, and once brings the position pointing member 7 away from the touch panel and then again brings the position pointing member 7 close to the touch panel 5, whereby it is made possible to switch a selectable color as a drawing color for display and select the color.

Further, when displaying the color used for drawing by the check marker 201, the control section (the control unit 100, the color display section 106, etc.,) uses lighter color than the color used for drawing. Accordingly, it is made possible for the user to clearly recognize that user's action is selection of a drawing color.

The touch panel system further includes a distance detection section (contained in the closeness detection section 102) for detecting the distance between the position pointing member 7 and the touch panel 5 based on the detection result of the closeness detection section 102). Based on the detection result of the distance detection section, the control section (the control unit 100, the color display section 106, etc.,) displays the color used for drawing lighter as the distance between the position pointing member 7 and the touch panel 5 is larger. Further, the display size of the check marker 201 may be changed in response to the distance.

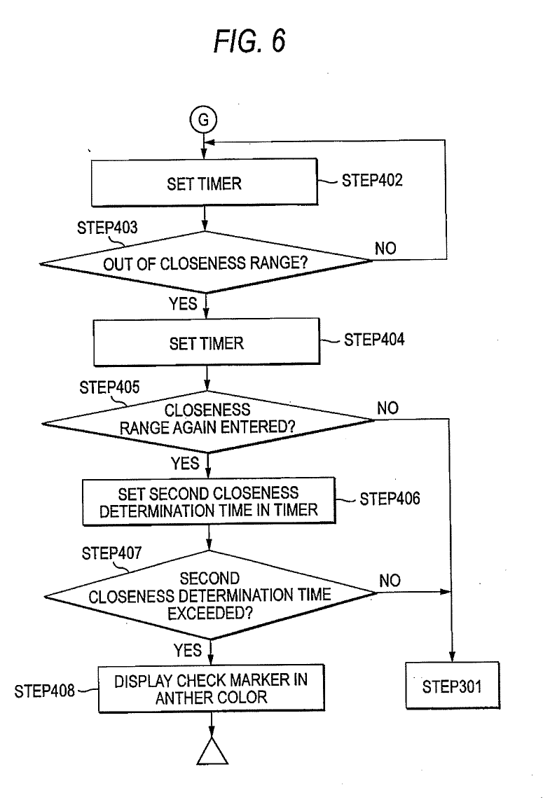

FIG. 6 is a flowchart to show color change processing in the touch panel system according to Embodiment 1 of the invention. FIG. 6 shows color change processing after the check marker 201 becomes a display state, and shows a continuation of “G” shown in the flowchart of FIG. 5.

The description is continued below with FIG. 6 together with FIGS. 3 and 4:

The control unit 100 again sets the timer 103 to a predetermined value (STEP402) and determines whether or not the position pointing member 7 is placed out of the closeness range 71 with respect to the touch panel 5 within a predetermined time (STEP403). Whether or not the position pointing member 7 is placed out of the closeness range 71 is determined based on the detection result of the closeness detection section 102 as previously described with FIG. 5. The predetermined time may be set to 0.5 to 0.8 sec, for example.

That is, the control unit 100 erases a detection signal for detecting that the position pointing member 7 exists in the closeness range 71 of the touch panel 5 within the predetermined time or outputs a non-detection signal for detecting that the position pointing member 7 exits the closeness range 71 of the touch panel 5 within the predetermined time.

If the control unit 100 determines that the position pointing member 7 is once placed out of the closeness range 71 based on the detection result of the closeness detection section 102 (YES at STEP403), the control unit 100 again sets the timer 103 to a predetermined value (STEP404) and determines whether or not the position pointing member 7 enters the closeness range 71 (STEP405). This situation is detecting of action of the user of the touch panel system 300 bringing a finger or a stylus pen (the position pointing member 7) close to the surface of the touch panel 5 and then away from the surface of the touch panel 5.

If the control unit 100 determines that the position pointing member 7 again enters the closeness range 71 (YES at STEP405), the control unit 100 further sets the second closeness determination time in the timer 103 (STEP406) and determines whether or not the second closeness determination time is exceeded while the state in which the position pointing member 7 enters the closeness range 71 is maintained (STEP 407).

If the control unit 100 determines that the second closeness determination time is exceeded, to change the drawing color, the control unit 100 acquires color information concerning another color previously set (stored) as a selectable color candidate in the color management section 104 and instructs the color management section 104 and the color change section 105 to change the color to be displayed as the check marker 201 based on the color information (STEP408).

The check marker 201 displayed according to the instruction differs from the marker previously described with FIG. 5 only in display color and the display coordinates, the check marker color thickness, size, change of color, size, etc., based on the distance are controlled in a similar manner and therefore will not be discussed again.

At STEP405, if the position pointing member 7 does not again enter the closeness range 71 (NO at STEP405) or at STEP407, the position pointing member 7 is placed out of the closeness range 71 before the second closeness determination time is not exceeded (NO at STEP407), the subroutine returns to STEP301. At this time, however, color is not initialized at STEP301 and the state of the drawing color already set is maintained.

Thus, in Embodiment 1, if the closeness detection section 102 detects that the position pointing member 7 is brought close to the touch panel 5 and then detects that the position pointing member 7 is not brought close to the touch panel 5 and further detects that the position pointing member 7 is again brought close to the touch panel 5 within preset second time (the second closeness determination), the control section (the color change section 105, the color display section 106, the MPU 10) switches and displays the setting of a new selectable function (for example, setting of drawing color) in a part of the touch panel 5 corresponding to the coordinate value.

Accordingly, the user brings the position pointing member 7 of a finger, a stylus pen, etc., close to the touch panel (detection face) 5, for example, and once brings the position pointing member 7 away from the touch panel and then again brings the position pointing member 7 close to the touch panel 5, whereby it is made possible to switch and display the setting of a selectable function and select it.

That is, the user brings the position pointing member 7 close to or away from the surface of the touch panel 5, whereby the user can know the setting of the current drawing color by first bringing the position pointing member 7 close to the surface and can switch (change) the setting of the drawing color by second or later bringing the position pointing member 7 close to the surface.

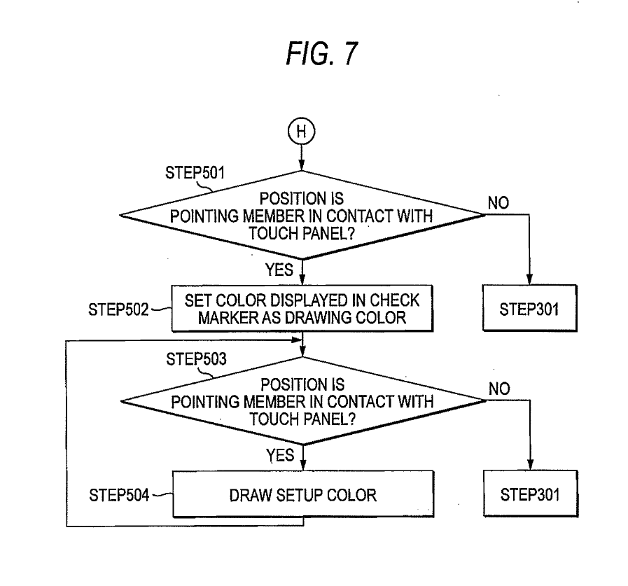

FIG. 7 is a flowchart of contact determination of the position pointing member in the touch panel system according to Embodiment 1 of the invention. FIG. 7 shows processing when the position pointing member 7 is brought into contact with the touch panel 5 from the closeness range and shows a continuation of “H” shown in the flowchart of FIG. 5.

The description is continued below with FIG. 7 together with FIGS. 3 and 4:

The transition from “H” shown in FIG. 5 to “H” shown in FIG. 7 is made when the position pointing member 7 is placed out of the closeness range 71 before the first closeness determination time is exceeded or when the position pointing member 7 comes in contact with the touch panel 5.

Then, first the control unit 100 references the detection result of the contact detection section 101 and determines whether or not the position pointing member 7 is in contact with the touch panel 5 (STEP501).

If the control unit 100 determines that the position pointing member 7 is not in contact with the touch panel 5 (NO at STEP501), the control unit 100 determines that the position pointing member 7 is placed out of the closeness range 71 and returns to STEP301 shown in FIG. 5.

If the control unit 100 determines that the position pointing member 7 is in contact with the touch panel 5 based on the detection result of the contact detection section 101, the control unit 100 notifies the color management section 104 that the drawing color is determined, and sets the color displayed in the check marker 201 as the drawing color (STEP502).

While the position pointing member 7 is in contact with the touch panel 5 (STEP503), drawing is continued using the current selected color (STEP504).

In drawing, the coordinate value used as the coordinates for displaying the check marker 201 is continued as it is. This enables the user to make a direct transition from the display state of the check marker 201 to the actual drawing state.

If the control unit 100 detects that the position pointing member 7 is brought away from and is not in contact with the touch panel 5 based on the detection results of the contact detection section 101 and the closeness detection section 102, the process goes to STEP301 shown in FIG. 5.

In Embodiment 1, as the setup state of the touch panel system, the description is given by taking display and change of the drawing color as an example. However, even as for the thickness of the line to be drawn, the thickness of the line may be displayed as a direct image. Accordingly, it is made possible for the user to clearly recognize that the user's action is selection of the line in drawing.

Thus, the touch panel system of Embodiment 1 further includes the contact detection section 101 for detecting whether or not the position pointing member 7 comes in contact with the touch panel (detection face) 5. If the contact detection section 101 detects that the position pointing member 7 comes in contact with the detection face 5, the control section (the control unit 100, the color management section 104) determines the setting of the current display function, namely, determines that the color of the check marker 201 is the drawing color.

That is, the user brings the position pointing member 7 close to or away from the surface of the touch panel 5, whereby the user can know the setting of the current drawing color by first bringing the position pointing member 7 close to the surface and can switch the setting of the drawing color by second or later bringing the position pointing member 7 close to the surface and then, following any of the actions, if the user brings the position pointing member 7 into contact with the touch panel 5, the color displayed as the check marker 201 can be determined to be the drawing color.

That is, considering such a time element, it can be said that Embodiment 1 is a setup state display method of the touch panel system for detecting whether or not the predetermined position pointing member 7 of a finger, a stylus pen, etc., is brought close to the touch panel (detection face) 5, calculating the coordinate value on the detection face 5 when the position pointing member 7 is brought close to the detection face 5, and if it is detected that the position pointing member 7 is close to the detection face 5 for the preset first time or more, displaying the setting of the current setup function in the part of the detection face 5 corresponding to the coordinate value and further is a setup state display method of the touch panel system for switching and displaying the setting of a new selectable function (for example, color) in the part of the detection face 5 corresponding to the coordinate value of the detection face 5 if it is detected that the position pointing member 7 is brought close to the detection face 5 and then it is detected that the position pointing member 7 is not close to the detection face 5 and then further it is detected that the position pointing member 7 is again brought close to the detection face 5 within the preset second time.

According to the setup state display method, the user can bring the position pointing member 7 close to the detection face 5, thereby acknowledging the setting of the current setup function, and further can bring the position pointing member 7 close to the detection face 5 and then once the position pointing member 7 away from the detection face 5 and then again bring the position pointing member 7 close to the detection face 5, thereby switching and displaying the setting of selectable function and then can bring the position pointing member 7 into contact with the detection face 5, thereby determining the setting and then drawing (writing onto the touch panel 5) in accordance with the setting.

Embodiment 1 of the invention has been described using the self-capacitance detection system of scanning the first electrodes 23 and the second electrodes 24 in order (see FIG. 8); instead, a mutual capacitance detection system of forming the first electrodes 23 as transmission electrodes and the second electrodes 24 as reception electrodes and scanning electrostatic capacity change at the electrode cross positions individually may be adopted. The mutual capacitance detection system makes it possible to detect a state in which a plurality of position pointing members 7 are close to/in contact with the touch panel 5 at the same time (multi-touch input).

In such a multi-touch environment, two or more users share the touch panel 5 and thus it is assumed that the function, etc., may be unable to be switched smoothly depending on the positional relationship between the users. However, an extremely-easy-to-use touch panel system can be provided by applying the invention.

The invention is not limited to the configuration wherein contact or close position (coordinates) of the position pointing member 7 is detected using change in the electrostatic capacity as described in Embodiment 1. The invention can also be applied to a configuration wherein it can be detected that the position pointing member 7 is brought close to the touch panel 5, for example, a configuration wherein closeness of the position pointing member 7 is detected with an ultrasonic wave or by performing image processing.

Particularly, to apply the invention to a touch panel system including a large touch panel, the function descriptions of the current setup color and line width, etc., can be checked and the setting can be switched regardless of the position of the face of the touch panel.

The invention can be used not only for general input units represented by a touch panel, but also for an interactive board, an electronic blackboard, and other business machines.

This application is based upon and claims the benefit of priority of Japanese Patent Application No 2009-129884 filed on Sep. 5, 1929, the contents of which are incorporated herein by reference in its entirety.

1. A touch panel system, comprising:
a detection face that is capable of making entry or position detection;
a closeness detection section for detecting that a pointing member is brought close to said detection face;
a coordinate calculation section for calculating the position coordinates of a point where the normal pulled down from the pointing member to said detection face and said detection face cross each other and its surrounding proximity when said closeness detection section detects that the pointing member is brought close to said detection face;
a time count section for counting the time during which the pointing member stays within a predetermined range from said detection face if said closeness detection section detects that the pointing member is brought close to said detection face; and
a control section for displaying an information menu at a position corresponding to the coordinate value calculated by said coordinate calculation section on said detection face or its proximity position if the time counted by said time count section exceeds a predetermined time.

2. A touch panel system comprising:
a detection face capable of making entry or position detection;
a closeness detection section for detecting that a pointing member is brought close to said detection face;
a coordinate calculation section for calculating the position coordinates of a point where the normal pulled down from the pointing member to said detection face and said detection face cross each other and its surrounding proximity when said closeness detection section detects that the pointing member is brought close to said detection face;
a time count section for counting the time during which the pointing member stays within a predetermined range from said detection face if said closeness detection section detects that the pointing member is brought close to said detection face; and
a control section, when said closeness detection section detects that the pointing member is brought close to said detection face and subsequently does not detect that the pointing member is brought close to said detection face and again detects that the pointing member is brought close to said detection face, if the time counted by said time count section exceeds a predetermined time, said control section for displaying an information menu at a position corresponding to the coordinate value calculated by said coordinate calculation section on said detection face or its proximity position.

3. The touch panel system as claimed in claim 2, wherein the information menu displayed by said control section is an information menu different from an information menu set before said closeness detection section detects that the pointing member is again brought close to said detection face.

4. A touch panel system comprising:
a detection face capable of making entry or position detection;
a closeness detection section for detecting that a pointing member is brought close to said detection face;
a coordinate calculation section for calculating the position coordinates of a point where the normal pulled down from the pointing member to said detection face and said detection face cross each other and its surrounding proximity when said closeness detection section detects that the pointing member is brought close to said detection face;
a time count section for counting the time during which the pointing member stays within a predetermined range from said detection face if said closeness detection section detects that the pointing member is brought close to said detection face; and
a control section for displaying a setting menu of a color used for drawing at a position corresponding to the coordinate value calculated by said coordinate calculation section on said detection face or its proximity position if the time counted by said time count section exceeds a predetermined time.

5. The touch panel system as claimed in claim 4 wherein when a color used for drawing is displayed, said control section uses a color lighter than that when used for drawing.

6. The touch panel system as claimed in claim 3 further comprising a distance detection section for detecting the distance between the pointing member and said detection face, wherein
said control section displays the color used for drawing lighter as the distance between the pointing member and said detection face is larger based on the detection result of the distance detection section.

7. The touch panel system as claimed in claim 1 comprising matrix-like electrodes provided along said detection face, wherein
said closeness detection section determines whether or not the pointing member is brought close to said detection face based on change in the electrostatic capacity between the electrodes.

8. An interactive board comprising a touch panel system as claimed in claim 1.

9. An interactive board comprising a touch panel system as claimed in claim 2.

10. An interactive board comprising a touch panel system as claimed in claim 4.

11. An electronic blackboard comprising a touch panel system as claimed in claim 1.

12. An electronic blackboard comprising a touch panel system as claimed in claim 2.

13. An electronic blackboard comprising a touch panel system as claimed in claim 4.

14. A business machine comprising a touch panel system as claimed in claim 1.

15. A business machine comprising a touch panel system as claimed in claim 2.

16. A business machine comprising a touch panel system as claimed in claim 4.
